(19) United States
(12) Patent Application Publication
(10) Pub. No.: US 2025/0261732 A1
(43) Pub. Date: Aug. 21, 2025

(54) LUGGAGE WITH BUILT-IN SCALE

(71) Applicant: TrendyGroup NYC Inc., Sunny Isles Beach, FL (US)

(72) Inventor: Joseph Lati, Sunny Isles Beach, FL (US)

(21) Appl. No.: 19/049,065

(22) Filed: Feb. 10, 2025

Related U.S. Application Data
(60) Provisional application No. 63/555,762, filed on Feb. 20, 2024.

(51) Int. Cl. A45C 5/03; A45C 5/14; G01G 19/52

(52) U.S. Cl. CPC A45C 5/03; A45C 5/14; G01G 19/52

(57) ABSTRACT

A suitcase includes a scale operatively coupled with one or more ground supports that enable a user to determine the current weight of the suitcase and its contents without the need for external equipment. The suitcase can include a display that can show the determined current weight. In embodiments, the suitcase includes a processor that enables functions such as detecting potential theft of contents from the suitcase or the unauthorized introduction of items.

This application claims priority to U.S. provisional application 63/555,762, filed Feb. 20, 2024. U.S. provisional application 63/555,762 and all other extrinsic references contained herein are incorporated by reference in their entirety.

### FIELD OF THE INVENTION

The field of the invention is luggage technologies.

### BACKGROUND

The background description includes information that may be useful in understanding the present invention. It is not an admission that any of the information provided herein is prior art or relevant to the presently claimed invention, or that any publication specifically or implicitly referenced is prior art.

Every traveler knows the anxiety of trying to stay under an air carrier's baggage weight limit. Packing at home, adding and subtracting items from a suitcase and weighing and re-weighing the suitcase using a common bathroom scale to maximize the items packed without having to pay extra for overweight baggage.

And then, the traveler gets to the airport and sees that the scale at the airport shows the suitcase is overweight. Thus begins the embarrassing process of opening the suitcase to transfer items out in front of everyone at the check-in line. Or, if that alternative isn't available, simply having to pay overweight fees that can go into the hundreds of dollars.

Thus, there is still a need for a system that accurately weighs a packed suitcase and provides information to the user such that the user knows with a satisfying certainty how much their suitcase weighs throughout the process of packing, going to the airport, and check-in.

Additionally, after check-in, there is a risk that something will be taken from the suitcase or, more dangerously, added to the suitcase after it has left the owner's care. Thus, there is a need for a system that can detect changes in the contents of a suitcase when it is no longer in the owner's possession.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods in which a suitcase having a suitcase cavity has one or more scales disposed within the cavity. The scale(s) is connected to one or more of the ground supports (e.g., feet or wheels) of the suitcase. This way, the scale can measure the current weight of the suitcase.

In embodiments of the inventive subject matter, the suitcase includes a display that is configured to display the current weight determined by the scale(s).

The suitcase can also include a battery that may be removable, in certain embodiments.

In embodiments of the inventive subject matter, the suitcase includes a processor. The processor can perform various functions including accounting for the weight of the empty suitcase. In other embodiments, the scale can be pre-calibrated to account for this weight.

In embodiments, the suitcase includes a sensor attached to a closing mechanism of the suitcase that is configured to detect when the suitcase is opened via the opening of the closing mechanism. In these embodiments, the processor receives a signal from the sensor and causes the scale to determine a new current weight. Then, if the current weight is sufficiently different from one or more previous measurements, the processor causes an alarm to occur that can be indicative of contents being removed or added to the suitcase without authorization.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 provides a diagrammatic overview of a suitcase, according to embodiments of the inventive subject matter.

FIG. 2 illustrates an alternative embodiments where the display is located on the top surface of the suitcase, according to embodiments of the inventive subject matter.

FIG. 3 illustrates a suitcase according to an alternative embodiment of the inventive subject matter.

FIG. 4 illustrates an embodiment of the inventive subject matter where the scale is coupled with lateral supports instead of the bottom supports.

FIG. 5 illustrates a variation of the embodiment of FIG. 4, with the individual scales discussed with regard to FIG. 3.

FIG. 6 illustrates an embodiment with foot supports that have integrated sensors, according to embodiments of the inventive subject matter.

FIG. 7 shows a detailed exploded view of the assembly of the foot support, according to embodiments of the inventive subject matter.

FIG. 8 illustrates a suitcase having a sensor on a closing mechanism, according to embodiments of the inventive subject matter.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

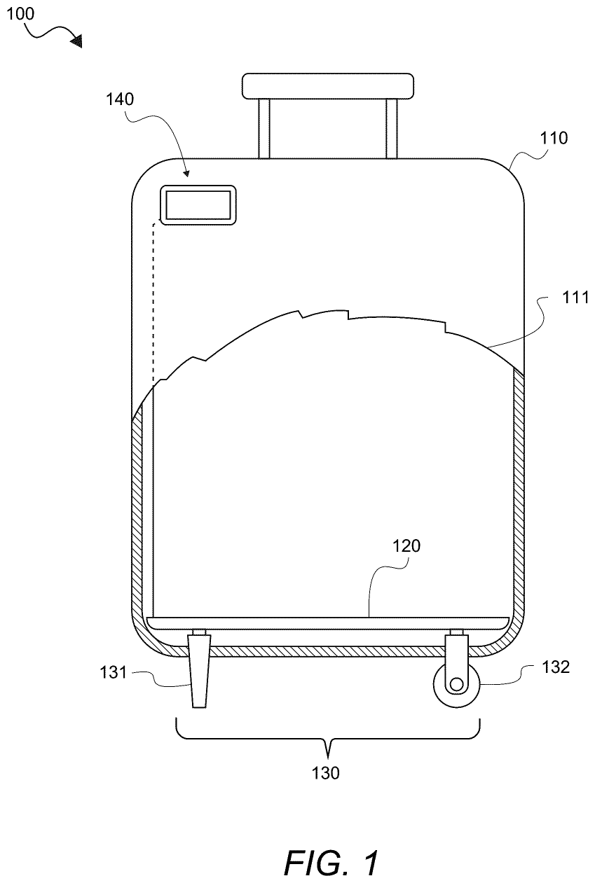

FIG. 1 provides a diagrammatic overview of a suitcase 100, according to embodiments of the inventive subject matter.

As seen in FIG. 1, the suitcase includes a suitcase body 110 that defines a cavity 111 within. The suitcase body 110 can include closing mechanisms such as zippers, clasps, latches, or other ways of accessing the cavity 111 as known in the luggage arts.

At a bottom end of the cavity 111, the suitcase body 110 includes a scale 120. The scale 120 is attached to the body 110 and one or more supports 130 (depicted here as a static support 131 and a wheeled support 132) such that the scale 120 can determine the weight of the suitcase 100 and its contents. The view of FIG. 1 only shows one support 131 and one wheeled support 132, but it is understood that support 131 can include a second support 131 that is not visible and a second wheeled support 132 that is not visible, so that the suitcase 100 has four supports 130. It is also understood that in other embodiments, the supports 130 can be entirely wheeled supports 132 or entirely static supports 131. A mix of both is illustrated here to show that various types of supports 130 are contemplated.

To do so, the scale 120 is directly coupled with the supports 130 at a bottom end and then elsewhere coupled with the body 110 such that the scale 120 can detect the weight of the suitcase body 110 and its contents relative to the supports 130 when the suitcase 100 is upright.

This approach allows for the entirety of the suitcase to be weighed when upright, even if the contents within the suitcase are distributed among different compartments within two halves of the suitcase 100.

In embodiments of the inventive subject matter, the scale 120 includes an on-board battery that powers the scale 120. In variations of these embodiments, the battery can be removable such that the suitcase 100 complies with rules and regulations regarding certain types of batteries in checked luggage.

The scale 120 also includes a processor that is programmed to perform various functions discussed herein.

In the embodiment of the inventive subject matter shown in FIG. 1, the suitcase 100 includes a display 140 communicatively connected with the scale 120. In preferred embodiments, the display 140 is disposed on the suitcase body 110 such that it is visible from the outside of the suitcase. The display 140 can, in embodiments, be a screen such as an LCD or LED screen. In these embodiments, the display 140 can display the current weight of the suitcase whenever the suitcase 100 is upright and the scale 120 activated.

In these embodiments, the display 140 can display the exact weight of the suitcase 100 in English and/or metric units. The display 140 can also provide other information such as battery life/status, owner information or other useful information. In embodiments, the display 140 can also change colors in addition to/instead of displaying a weight

The display 140 can include buttons or be a touchscreen display that allows a user to control certain functions of the scale 120. For example, the display 140 can include an on/off button that can cause the scale 120 to shut on or shut off. This way, the scale 120 is only activated when the user desires to see the weight of the suitcase 100 and not at other times when the suitcase 100 is upright (such as when moving through an airport, or when the suitcase is in a car or in the process of being loaded into an airplane). Other functions that could be controlled can include displaying the weight in metric or English units, the brightness of the display, setting the weight limit, etc.

The processor enables a user to enter a weight limit, via the display 140, that would cause the display 140 to show a message or a color corresponding to an overweight suitcase if the weight exceeds the entered limit. This enables the user to change the display 140 based on a particular air carrier's baggage rules and/or rules associated with particular routes.

In simplified embodiments of the inventive subject matter, the display 140 can be one or more lights (e.g., LED lights). In these embodiments, the LED lights can be controlled by the scale 120 to provide a first color (e.g., green) if the suitcase is below a particular weight, and a second color (e.g., red) if the suitcase is above a particular weight.

The scale 120 is programmed to account for the weight of the suitcase 100 itself, including the supports 131, 132 when determining the total amount of weight. Thus, the scale 120 determines the weight of the suitcase 100 by determining the weight of the contents within the cavity 111 and the suitcase body 110 and adding the predetermined weight of the supports 131, 132.

In embodiments of the inventive subject matter, the suitcase 100 includes a communication interface (e.g., cellular radio, NFC, Bluetooth radio, Wifi, etc.) that is coupled with the processor that enables the processor of the suitcase 100 to communicate with another computing device. For example, a user may have an application installed on their phone that communicates with the processor of the suitcase 100. This way, the user can see information such as the weight of the suitcase 100 on their phone. In addition, the user can ascertain a location of the suitcase via their phone. The user can also input their flight information into the application which can be shown on display 140, assisting baggage personnel or others in correctly routing the baggage. The display 140 can also show messages transmitted from the application. For example, if the suitcase 100 is lost by an airline, the display 140 can provide messages such as the user's contact information.

The processor can be arranged at different locations within the suitcase based on considerations such protecting the processor and associated circuitry, ease of connectivity with other components within the suitcase 100, ease of repair, etc. In the embodiments shown herein, the processor is considered to be integral to the display unit 140. In other embodiments,

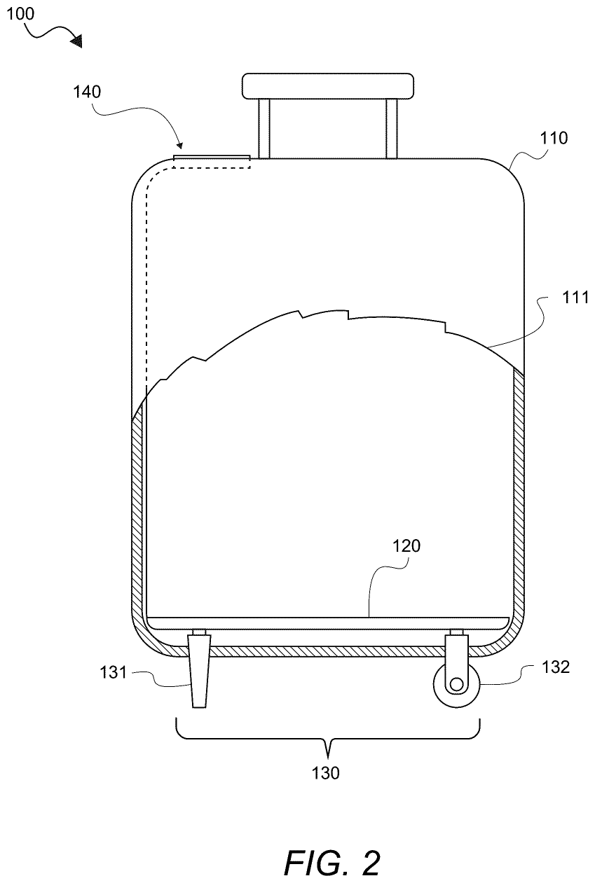

FIG. 2 illustrates an alternative embodiments where the display 140 is located on the top surface of the suitcase 100. This way, the display 140 can easily be read from above when the suitcase is standing. In the rest of the embodiments, the display 140 is shown as being on the top surface of the suitcase 100. However, it is contemplated that the display 140 could be on the side or any other surface of the suitcase 100. Additionally, it is contemplated that the suitcase 100 can have more than one display 140.

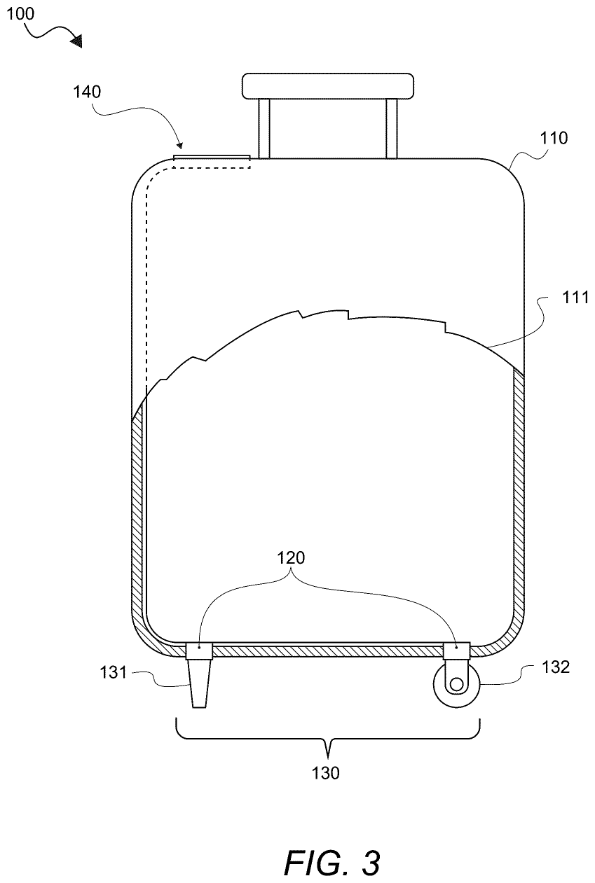

FIG. 3 illustrates an alternative embodiment of the inventive subject matter. In this embodiment, individual scales 120 are attached to each of the supports 131, 132. In this embodiment, each scale sends their measurements to the processor that then determines the total weight of the suitcase. In these embodiments, the processor can be programmed to only calculate a weight when it receives signals from all of the individual scales 120, so that it does not waste resources calculating a false weight based on signals from only some of the scales 120 (such as when the suitcase 100 is being rolled on two wheels during transit).

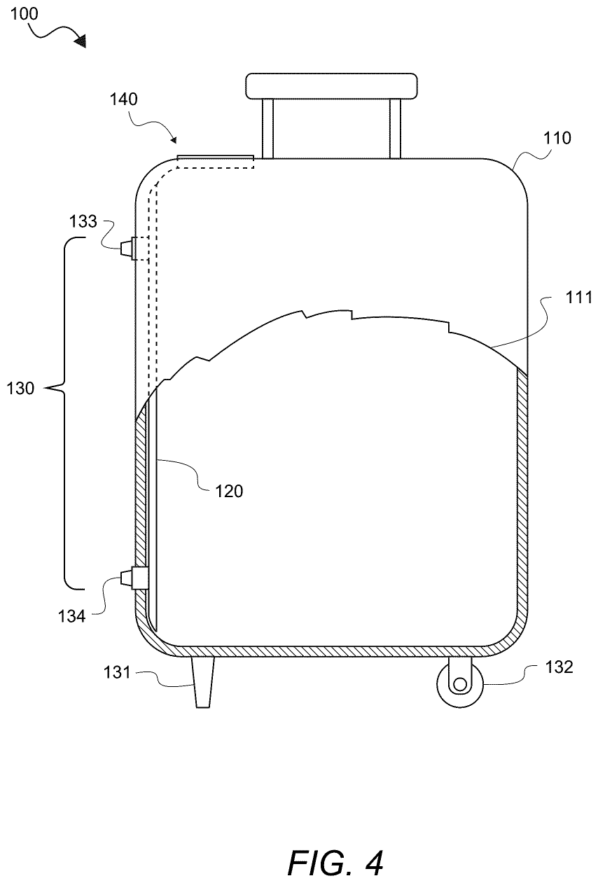

FIG. 4 illustrates an embodiment of the inventive subject matter where the scale 120 is coupled with lateral supports 133, 134 instead of the bottom supports 131, 132. This way, the scale 120 is activated when the suitcase 100 is on its side.

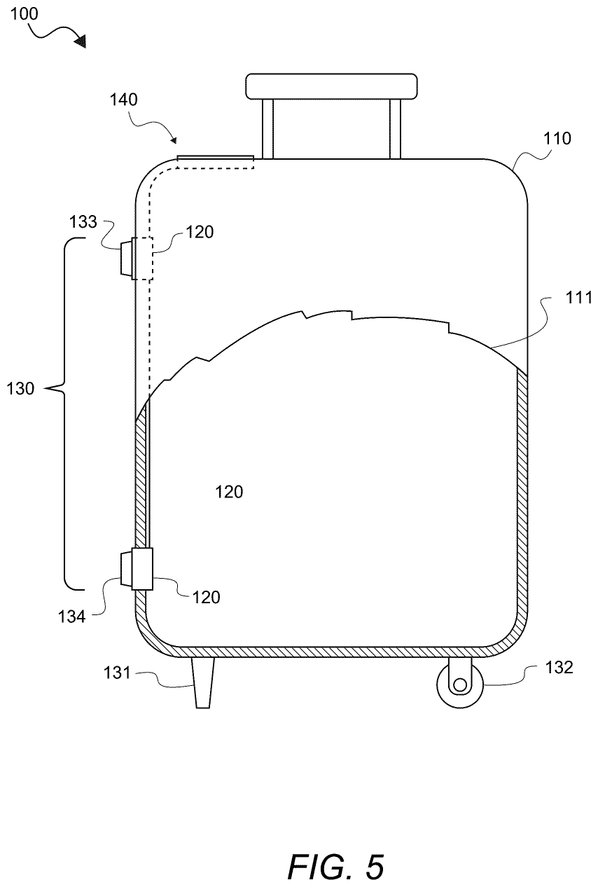

FIG. 5 illustrates a variation of the embodiment of FIG. 4, with the individual scales 120 discussed with regard to FIG. 3.

In the embodiments of FIGS. 1, 2 and 5, the scale 120 can be two scales 120 that each communicate with the processor, each scale 120 handling two supports 130. In these embodiments, the scales 120 are aligned with each half of the suitcase 100 such that the suitcase 100 can be opened normally.

In other embodiments of FIGS. 1, 2 and 5, the scale 120 has a surface that is separable such that when the suitcase 100 is opened, the surface of scale 120 separates such that a section of the scale 120 remains in each half of the suitcase 100. When the suitcase 100 is closed again, the scale 120 comes back together and can perform the functions discussed herein.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

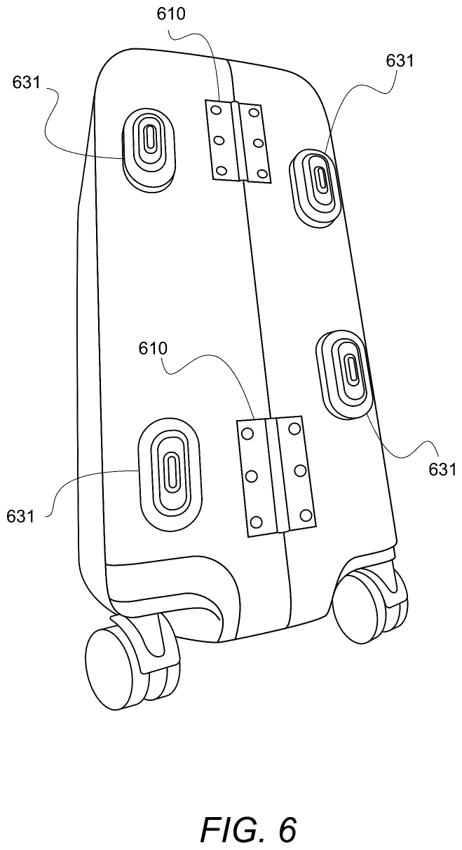

FIG. 6 illustrates an embodiment with foot supports 631 that have integrated sensors, according to embodiments of the inventive subject matter.

In the illustrated example of FIG. 6, the supports 631 are on the same side as hinges 610, and as such the arrangement is staggered relative to one another such that the supports 631 do not interfere with each other when the suitcase 100 is opened. Other arrangements of the supports 631 are contemplated for distribution on this and/or other sides of the suitcase 100.

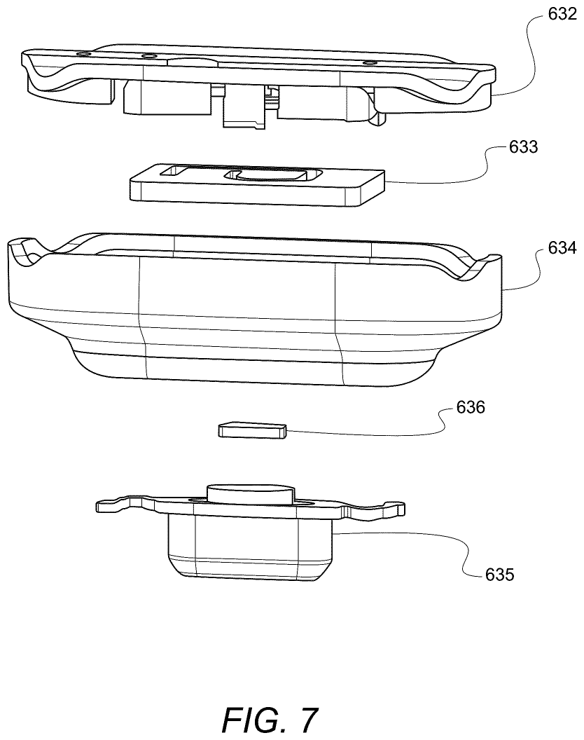

FIG. 7 shows a detailed exploded view of the assembly of foot support 631, according to embodiments of the inventive subject matter. As seen in FIG. 7, the foot support 631 includes a cover 632, a weight sensor 633 that is disposed between the cover 632 and sensor base 634. The footpad 635 is in contact with the weight sensor 633, such that the weight of the suitcase 100 presses the footpad 635 against the weight sensor 633. In embodiments of the inventive subject matter such as the one shown herein, the support 631 can also include a reinforcement element 636 that can be made of a sufficiently stiff material (e.g., iron or other metal, a hard plastic material, a hard rubber, etc.).

In embodiments of the inventive subject matter, the sensor 633 is a gravity sensor that converts the force exerted due to gravity acting on the suitcase (i.e., the weight of the suitcase) into electrical signals that are then transmitted to the processor for the various functions discussed herein.

The sensor base 634 is used to fix the various components of the foot support 631 to the body 110 of the suitcase 100. The sensor 633 is then affixed in place by the combination of the cover 632 and base 634. The inclusion of the reinforcement element 636 can improve the accuracy of weighing operations.

In the embodiment of FIGS. 6-7, the foot pad 635 contacts the ground and the force of the weight from the suitcase 100 is “passed” upward to the sensor 633 via the reinforcement member/element 636.

In embodiments of the inventive subject matter, the suitcase can include the ability to detect tampering with the suitcase when the suitcase is not in the owner's possession (such as after the suitcase has been checked at the check-in counter).

In embodiments of the inventive subject matter, the processor of scale 120 can be programmed to periodically take weight measurements. This can be in response to a user input setting the suitcase to a “tamper-detect” mode that begins the periodic measurements. If the weight sensor detects a change in weight above a certain threshold, it can communicate an alert to the user. In embodiments of the inventive subject matter, the processor can be programmed to determine whether the weight change is above a second threshold. If it is above a second threshold, it can ignore the change. This greater weight threshold could correspond to a weight that would be above the limit of the suitcase 100, which could then correspond to something heavy placed on top of the suitcase 100 (e.g., another piece of luggage within an aircraft's baggage hold).

While the embodiment above can be useful in detecting tampering, the possibility of false positives remains elevated because of the variability in the weight of the contents of the suitcase (lightly packed versus heavily packed) and how the suitcase 100 could be handled at an airport, or packed into an aircraft.

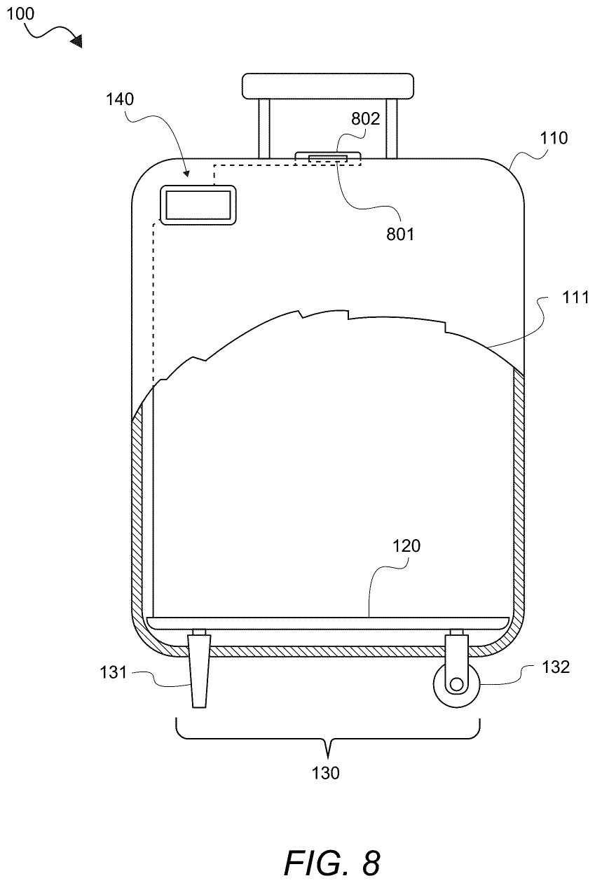

FIG. 8 illustrates an embodiment of the inventive subject matter that solves these challenges. In the embodiment of FIG. 8, the suitcase 100 includes a sensor 801 disposed on the zipper, latch, or other closing/securing mechanism 802 that can detect when the suitcase 100 is opened.

The sensor 801 can be a magnetic sensor that detects when two matching zipper

components are separated by a certain amount (when the closing mechanism 802 is a zipper), or that detects when the two corresponding pieces of a latch lock (such as the one illustrated in FIG. 8) are separated from each other. Other sensors that can be used to detect an opening of a latch, lock, zipper, etc are contemplated as well.

In these embodiments of the inventive subject matter, the processor detects, via sensor 801, when the closing mechanism 802 has been opened. Based on this signal, the processor then determines, via scale 120, the weight of the suitcase. If the weight varies from a prior determination by more than a threshold amount, the processor causes an alert to be sent via a wireless transmission to a computing device of the user (e.g., via Wifi, cellular, NFC, etc.).

Thus, at some time prior, the scale 120 determines the weight of the suitcase such as due to a user command or a periodic weighing. Then, in response to the signal from sensor 801, the processor causes the scale 120 to detect a current weight. The processor then compares the current weight to the most recent prior weight (can be the single most recent, or a plurality of recent measurements) and determines whether the current weight varies from the most recent prior weight(s) by an amount greater than the threshold amount. If so, the processor causes an alert to be sent to the owner's computing device.

In variations of these embodiments, the alert sent by the processor to the user can vary depending on how the weight varied. If the current weight is under the previous weights by more than the threshold amount, the alert can indicate that the weight of the suitcase 100 has decreased and can also indicate a possible theft. If the current weight is over the previous weight by more than the threshold amount, the alert can indicate that the weight of the suitcase 100 has increase and indicate that an unknown item has been introduced into the suitcase 100.

The alert can be in the form of a text/MMS message, an email, a social media message, an automated phone call, an alert on a dedicated application, or any other method of sending a message.

In embodiments of the inventive subject matter, the alert can also include a message on the display 140. The message can be/can include flashing of the display 140 to raise attention to the suitcase 100. In embodiments of the inventive subject matter, the suitcase 100 can include one or more speakers (e.g., within the housing of display 140 or other part of the suitcase), that can raise an audible alarm in response to an alert being determined.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A suitcase comprising:
a suitcase body, within which is disposed a suitcase cavity;
at least one support attached to a bottom of the suitcase body; and
a scale disposed within a bottom end of the suitcase cavity, the scale operatively coupled with the at least one support such that the scale can measure a current weight of the suitcase when the suitcase body is rested on the at least one support.

2. The suitcase of claim 1, wherein the at least one support comprises four supports.

3. The suitcase of claim 2, wherein at least two of the four supports comprise wheeled supports.

4. The suitcase of claim 1, wherein the scale further comprises a battery.

5. The suitcase of claim 4, wherein the battery comprises a removable battery.

6. The suitcase of claim 1, further comprising a display communicatively coupled with the scale.

7. The suitcase of claim 1, further comprising a processor programmed to:
determine a weight value corresponding to the current weight obtained from the scale; and
add a predetermined weight of the suitcase to the weight value.

8. The suitcase of claim 1, further comprising:
a processor;
a closing mechanism; and
a sensor configured to detect an opening of the closing mechanism, wherein the sensor is communicatively coupled with the processor;
wherein the processor is programmed to:
receive a signal from the sensor indicating that the closing mechanism has been opened;
cause the scale to measure the current weight;
compare the current weight to at least one past weight measurement;
determine whether the comparison results in a weight difference greater than a threshold; and
based on the determination, report an alarm.

9. The suitcase of claim 8, further comprising a wireless communication interface coupled to the processor, wherein the processor programmed to report an alarm further comprises sending, via the wireless communication interface, a message to a computing device.

10. The suitcase of claim 9, wherein the message comprises at least one of a text message, an audio message, a video message, an email, or a notification via an application.

11. The suitcase of claim 8, wherein the suitcase comprises a display coupled to the processor, and wherein the processor programmed to report an alarm further comprises the processor programmed to cause a display of an alarm message on the display.
